(19) United States
(12) Patent Application Publication
(10) Pub. No.: US 2009/0088125 A1
(43) Pub. Date: Apr. 2, 2009

(54) System and Method for Locating a Cellular Telephone in an Emergency

(75) Inventors: Steven M. Wollmershauser, San Antonio, TX (US); William O. Sprague, JR., Wimberley, TX (US); Emlyn C. Jeffrey, San Antonio, TX (US)

Correspondence Address: AT&T Legal Department - LNAP;Attn: Patent Docketing, Room 2A- 207, One AT & T Way, Bedminster, NJ, 07921, US

(73) Assignee: AT&T KNOWLEDGE VENTURES, LP, Reno, NV (US)

(21) Appl. No.: 11/865,406

(22) Filed: Oct. 1, 2007

(51) Int. Cl. H04M 11/04; H04M 1/00

(52) U.S. Cl. 455/404.2; 455/556.1; 455/572

(57) ABSTRACT

A system and method are disclosed for providing information about a cellular telephone. The method comprises determining that an emergency condition exists, and acquiring a location of the cellular telephone. Audio, a still image, or a video image are also acquired from the cellular telephone, and provided with the location of the cellular telephone on a server.

### FIELD OF THE DISCLOSURE

The present disclosure generally relates to communications networks, and more particularly relates to locating cellular telephones in an emergency.

### BACKGROUND

Federal law requires that all Personal Communications System networks and mobile communications networks be capable of providing location information for wireless calls made to emergency services. Phase II of the Federal Communications Commission wireless E911 mandate requires that technology be in place such that a dispatcher can know more precisely where the caller is located, a capability called Automatic Location Information.

Location technologies can be classified into at least three categories, including stand-alone, satellite-based, and terrestrial-based. A stand-alone system need not rely on multiple range measurements to determine the caller's position, but can attempt to provide the location based on power level, for example. Satellite-based systems such as Global Positioning System (GPS) provide very good accuracy and availability; however, impediments to line-of-sight can impact its usefulness. Terrestrial-based systems use existing cellular network base station transceivers (BTSs) for ground-based communications. The BTS transmits multiple ranging signals for a mobile station (or cell phone) in order to determine its location. BTSs are added based upon the density of people residing in a certain geographic area. Consequently, more BTS exist in an area of higher population density than in an area of lower population density, which is optimized for communications purposes, and not for location services.

One method of determining the location of a wireless caller via a terrestrial-based system is by Time Difference of Arrival (TDOA) technology. The TDOA technique works based on triangulation by measuring the time of arrival of a mobile station radio signal at three or more separate cell sites. In a cellular system using TDOA, a caller will place an emergency 9-1-1 call that is received at several BTSs, although only one BTS is assigned by the network to provide cellular communications service to the caller. A BTS is part of a Base Station Subsystem (BSS), which includes the BTS and a Base Station Controller (BSC). Each BTS receiving the 9-1-1 call signal will pass it through the BSC to a Mobile Switching Center (MSC).

The MSC is part of a Network and Switching Subsystem (NSS) and is a cellular central office that can perform all switching and signaling for cellular telephones in the MSC's area by routing calls between the mobile network and a fixed telephone network such as the Public Switched Telephone Network (PSTN). TDOA equipment at the MSC will determine the difference in time that the 9-1-1 signal arrived at each of three or more BTS sites and calculate the latitude and longitude of the caller based on the time difference and triangulation. The MSC then forwards the 9-1-1 call, along with the caller's location, to the emergency services dispatcher at a correct Public Safety Answering Point (PSAP).

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a functional block diagram of an exemplary system for providing mobile station tracking in a wireless telecommunication system consistent with an embodiment of the present disclosure; and

FIG. 2 is a flow chart of an exemplary method for receiving information from a mobile station; and

FIG. 3 is a flow chart of an exemplary method for making available the information uploaded by the mobile station.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

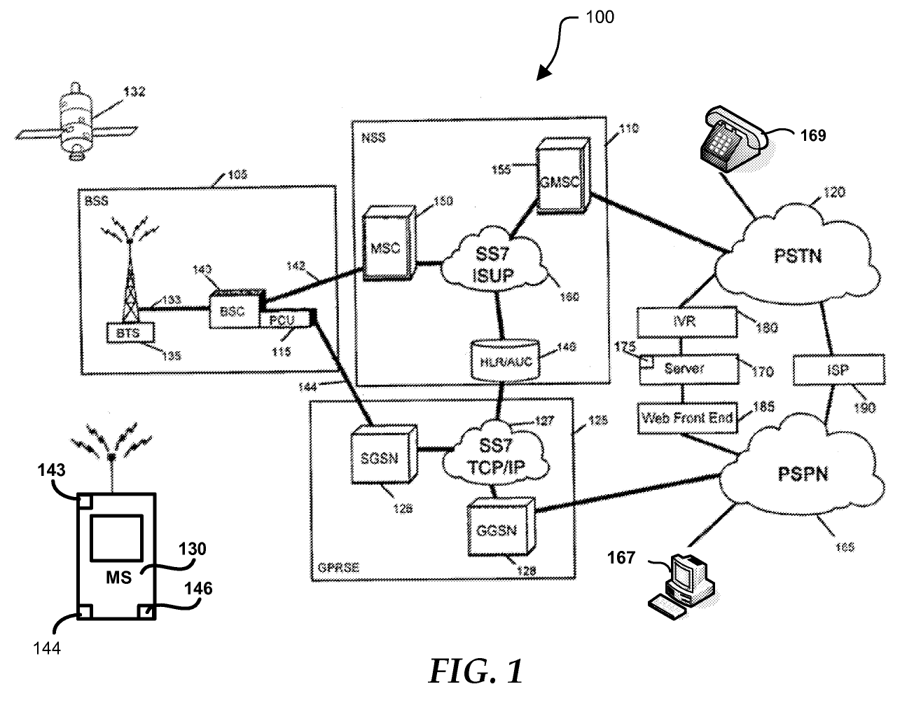

FIG. 1 shows a system 100 for providing mobile station tracking that may include a base station subsystem (BSS) 105, a network and switching subsystem (NSS) 110, a public switched telephone network (PSTN) 120, a mobile station (MS) such as a cellular telephone 130, a public switched packet network (PSPN) 165 such as the Internet, a tracking server 170, and a tracking database 175. BSS 105 may comprise, for example, a base station controller (BSC) 140, a base transceiver station (BTS) 135, and a packet control unit (PCU) 115.

BSC 140 controls BTS 135 and may control a plurality of other base transceiver stations in addition to the BTS. BTS 135 may comprise radio transmission and reception equipment located at an antenna site. Associated with BSS 105, a transcoder/rate adaptation unit (TRAU) (not shown) may perform speech encoding and speech decoding and rate adaptation for transmitting data. As a subpart of BTS 135, the TRAU may be located away from BTS 135, such as at a mobile switching center located in NSS 110. When the TRAU is located in this way, the low transmission rate of speech code channels allows more compressed transmission between BTS 135 and the TRAU.

BSS 105 may connect to MS 130 through a wireless interface using global system for mobile communications (GSM) technology enhanced with general packet radio service (GPRS) in certain embodiments. GSM phones may use a subscriber identity module (SIM) card that contains user account information. GSM phones are typically automatically programmed by plugging in the SIM card, allowing GSM phones to be used interchangeably in situations such as renting or borrowing. When a subscriber's SIM card is inserted into the MS 130, all calls for the subscriber are delivered to the MS. In addition, GSM phones may include short messaging service (SMS) that enables text messages up to 160 characters in length to be exchanged. SMS was first introduced in the GSM system and later supported by other digital-based mobile communication systems. Unlike paging, short messages are stored and forwarded in SMS centers. SMS messages travel to mobile stations over the wireless telecommunication system's control channels, which are separate and apart from voice channels. GSM supports data transfer rates of 9.6 Kbps to packet networks.

GPRS is an enhancement for GSM that supports packetized data. GPRS enables a continuous flow of Internet Protocol data packets over the telecommunication system for applications such as Web browsing and file transfer. Unlike SMS, GPRS has no message length limits. Additionally, those skilled in the art will appreciate that EDGE is an enhancement to the GSM and TDMA wireless telecommunication systems that increases data throughput. Those of ordinary skill in the art will appreciate that other wireless telecommunication technology standards may be employed in addition to GSM and GPRS, such as FDMA, TDMA, CDMA, CDMA2000, UTMS, and EDGE, without departing from the spirit of the invention. Wireless telecommunication may include radio transmission via the airwaves, and those of ordinary skill in the art will appreciate that various other telecommunication techniques can be used to provide wireless transmission including infrared line of sight, cellular, microwave, satellite, Bluetooth packet radio, and spread spectrum radio. Wireless data may include paging, text messaging, e-mail, Internet access, instant messaging, and other specialized data applications.

GSM systems may use open system interconnection (OSI). There are several common interfaces defined by OSI such as a common radio interface (referred to as air interface) used between MS 130 and BTS 135, and an A-bis interface 133 used between BTS 135 and BSC 140. With common interfaces such as those defined by OSI, a telecommunication system operator can utilize and interchange equipment of various manufactures when implementing communication systems. The difference between interface and protocol is that an interface represents the point of contact between two adjacent entities (equipment or systems) and a protocol provides information flows through the interface. For example, the GSM radio interface is the transit point for information flow pertaining to several protocols.

BS 105 connects to NSS 110 through an interface 142 that may comprise T-1 lines using X.25 or TCP/IP protocol, for example. PCU 115 connects BSS 105 to GPRSE 125 which allows, for example, MS 130 to link with the Internet. PCU 115 adds level 2 functions of GPRS such as data aware radio link control (RLC) and the MAC protocol layer as well as performing radio resource configuration and channel assignment.

MS 130 preferably includes a still/video camera 143 and a battery 144. The battery 144 is preferably a small “watch” battery that provides back-up power to MS 130 in case a rechargeable main battery 146 is unavailable for any reason. The back-up battery 144 is preferably is normally hidden from view and inaccessible, and is dedicated to a tracking function of MS 130 that is described below in greater detail. MS 130 may utilize cellular telephone protocols such as wireless application protocol (WAP). MS 130 alternately may be any device that, upon pressing a button on the MS, a preprogrammed telephone number or direct connect radio address may be called. This preprogrammed telephone number or address may be programmed when MS 130 is first initialized.

MS 130 may be configured to utilize the Global Positioning System (GPS). GPS is a system of satellites for identifying earth locations created by the United States Department of Defense. By triangulation of signals from three of the satellites in the GPS, which may include satellite 132, a receiving unit such as MS 130 can pinpoint its current location anywhere on earth to within a small margin of error. By using GPS, MS 130 may periodically calculate and/or send its location, in the form of geographic data, to server 170 either through NSS 110 and PSTN 120 or through GPRSE 125 and PSPN 165. The interfaces between PSTN 120 and tracking sever 170, and PSPN 165 and tracking server 170 will be described in greater detail below. Those of ordinary skill in the art will appreciate that there are many other ways to send geographic data from MS 130 to tracking server 170 including a direct connection from BSS 105, NSS 110, or GPRSE 125. In addition, those of ordinary skill in the art will appreciate that there are ways other than using GPS to obtain geographic data.

The NSS 110 may comprise a mobile switching center (MSC) 150, a first network 160, a home location register/authentication center (HLR/AUC) 146, and a gateway mobile switching center (GMSC) 155. NSS 110 manages the communication between a subscriber such as an operator using MS 130, and other telecommunication users such as those using PSTN 120. HLR/AUC 146 may comprise a stand-alone computer without switching capabilities, a database that contains subscriber information, and information related to the subscriber's current location, but not the actual location of the subscriber. The AUC portion of HLR/AUC 146 manages the security data for subscriber authentication. Another sub-division of HLR/AUC 146 may include an equipment identity register (EIR) (not shown) that may store data relating to the ME. NSS 110 may also include a visitor location register (VLR) (not shown). The VLR links to one or more mobile switching centers located on other systems, temporarily storing subscription data of subscribers currently served by MSC 150. The VLR holds more detailed data than HLR/AUC 146. For example, the VLR may hold more current subscriber location information than the location information at HLR/AUC 230.

The network 160 connects the elements of NSS 110, and may comprise an intelligent network utilizing signal system 7 (SS7) in an ISDN user part (ISUP) protocol. SS7 is a global standard for telecommunications defined by the Telecommunication Standardization Sector of the International Telecommunication Union. The SS7 standard defines the procedures and protocol by which network elements in a public switched telephone network exchange information over a digital signaling network to effect wireless and wireline call setup, routing, and control. ISUP defines the protocol and procedures used to set-up, manage, and release trunk circuits that carry voice and data calls over a public switched telephone network. ISUP is used for both ISDN and non-ISDN calls. Calls that originate and terminate at the same switch do not use ISUP signaling.

GMSC 155 interfaces with external networks for communication with users outside of the wireless system, such as users on PSTN 120. In order to set up a requested call, the call is initially routed to GMSC 155 to find the correct home location register by comparison with the known directory number of the subscriber. GMSC 155 has an interface with an external network, such as PSTN 120, for gatewaying communications. MSC 150 coordinates call set-up to and from subscribers using MS 130. MSC 150 may control several base station controllers similar to BSC 140.

GPRSE 125 may comprise a serving GPRS service node (SGSN) 126, a second network 127, and a gateway GPRS service node (GGSN) 128. The interfaces to the conventional GSM system may be augmented and an extra unit, such as PCU 115 that may be located in BSS 105 as described above, may be added. SGSN 126 connects GPRSE 125 to BSS 105 through interface 144, which may comprise T-1 lines using X.25 or TCP/IP protocol, for example. SGSN 126 receives the traffic from mobile subscribers associated with BSS 105 and forwards the traffic to GGSN 128. SGSN 126 uses its links with HLR/AUC 146 to authenticate and bill subscribers, and may provide additional services such as data compression, session management and encryption.

GGSN 128 acts as a gateway to PSPN 165, which is most often a PSPN such as the Internet. Data is sent across the GPRS network to GGSN 128, un-encapsulated, and then forwarded to the next node. To the outside world GGSN 128 may appear as just another router on the Internet. Common features of GGSN 128 may include firewall/packet-filtering technologies and a dynamic host configuration protocol (DHCP) server to configure IP options of MS 130 as it logs on to the network. DHCP automatically assigns IP addresses to client stations logging on to a TCP/IP network. DHCP software typically runs in servers and is also found in network devices such as ISDN routers and modem routers that allow multiple users access to the Internet. SGSN 126 and GGSN 128 are connected through second network 127. Second network 127 may employ SS7 as described above and may use TCP/IP.

Tracking database 175 may be located on storage media in tracking server 170 or on other storage media in systems, servers, or components accessible by tracking server 170. Tracking database 175 may at least comprise geographic data that may include geographic coordinates of MS 130 such as latitude and longitude at a given time. Those of ordinary skill in the art will appreciate, however, that the geographic data may include elements other than coordinates of MS 130 at a given time.

An interactive voice response (IVR) system 180 connects tracking server 170 to PSTN 120. An IVR is an automated telephone answering system that responds with a voice menu and allows the user to make choices and enter information via a telephone keypad. As an enhancement to IVR 180, a voice portal (not shown) may be employed. With a voice portal, rather than pressing keys of a dual-tone multi-frequency (DTMF) keypad, a user may speak a word or phrase into a microphone on a communication unit such as landline telephone 169 in order to make a menu selection. IVR systems are widely used in call centers to complement human operators, and may also integrate database access and fax response. From IVR 180, the data may then be pushed onto a LAN, for example, to tracking server 170 and stored in tracking database 175.

A web front end 185 connects tracking server 170 to PSPN 165. One function of web front end 185 is to provide an Internet interface for tracking server 170. The web front end 185 is a computer system that receives hypertext transfer protocol (http) requests from a web browser computer program directed to a specific URL, and provides responses to the requesting computer system that, when processed by the web browser computer program, displays a page of the Internet web site associated with the URL. For example, an exemplary URL employed for the present invention may comprise “http://www.trackingdata.com.” Directing an Internet-connected computer system with an operative Internet web browser program at this URL causes display of the home page associated with this web site on the computer's display. Such operations are well known to those skilled in the art and will not be discussed further herein. A communication unit such as a personal computer 167 may connect to tracking server 170 through PSPN 165 and web front end 185. It should be appreciated that tracking data server 170, tracking database 175, IVR system 180, web front end 185 and an Internet service provider (ISP) 190 may be owned, operated, and maintained by an operator of system 100 or by a third party. Further details of the system 100 are taught in Patent Application Publication No. US 2004/0202292, the disclosure of which is hereby incorporated by reference.

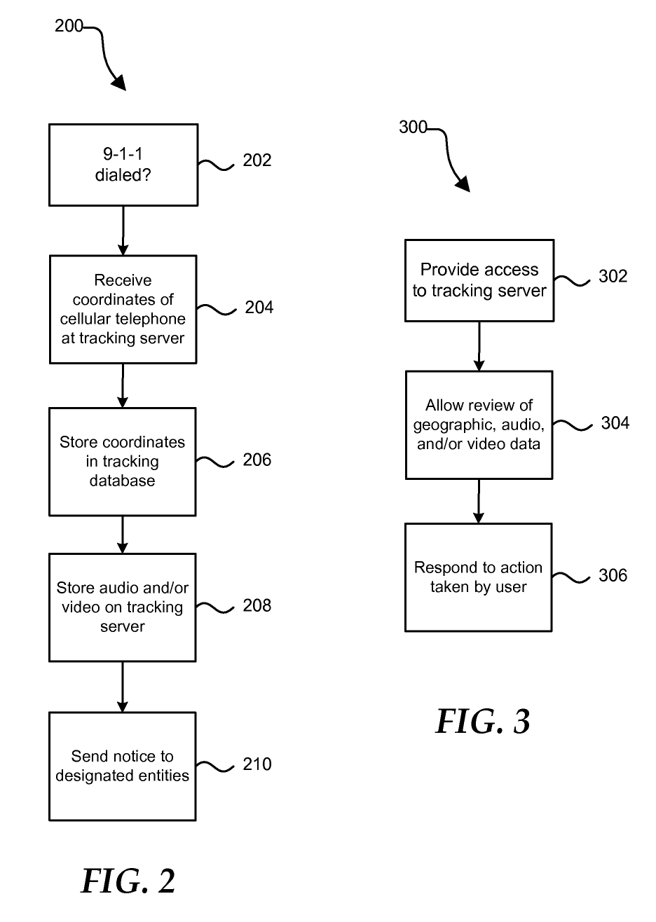

FIG. 2 shows an exemplary method 200 for uploading information from MS 130. At block 202, the method determines whether the preprogrammed button, or a series of buttons such as 9-1-1, has been entered on MS 130. If so, the method 200 at block 204 activates GPS tracking or triangulation tracking such as TDOA of the phone and stores that information, such as locally or in tracking server 170. This process continues even if the phone is powered off or the main battery 146 is disabled or removed, with backup battery 144 continuing to provide uninterruptible power. For example, MS 130 may be configured to periodically determine its position, and send those coordinates to the tracking server 170 where they are associated with the date and time and stored in the tracking database 175 at block 206. Those of ordinary skill in the art will appreciate that the geographic data may comprise many different types of data in various formats. The geographic data may be transmitted to tracking server 170 through, for example, BSS 105, NSS 110, and PSTN 120; BSS 105, GPRSE 125, and PSTN 165; or through a direct connection (not shown) between tracking server 170 and BSS 105, NSS 110, or GPRSE 125. Those skilled in the art will appreciate that there are many different ways to transfer the geographic data from MS 130 to tracking server 170.

The phone 130 may also automatically transmit audio, still images, and/or video images from the camera 143 to the tracking server 170 at block 208 after the dedicated button or telephone number is entered. The audio and images are preferably sent at increments that may be predetermined but alterable. For instance, five-second sound clips may be uploaded every thirty seconds, and a still image may be uploaded every sixty seconds. These settings may also be reset remotely, up to and including continuous audio and video feeds to the tracking server 170.

A notice may be sent to predesignated entities such as parents or emergency services personnel at block 210. The notice may be in one or more common formats such as email, text message, voice, or an automated message.

FIG. 3 shows an exemplary method 300 for making available the information uploaded by the MS 130 to the tracking server 170. After sending the notice, the method provides access at block 302 to the tracking server. For example, the method may provide a designated user with a personal identification number to access the preferably secure tracking server through either web front end 175 or through IVR 180. Thus, at block 304 the tracking server 170 may through web front end 185 present a tracking web page that includes a map with a tracking indicator illustrating where MS 130 was at a particular time. The information presented by the method may of course be updated in real time. If Internet web pages are used, for example, refreshed data screens may be presented showing the contemporaneous location as MS 130 moves over time. Similar information may be provided through other communication channels such as email or the IVR 180.

The method may also allow access to any audio, still images and/or video images stored on the tracking server. It should be appreciated that the audio, still images and/or video images may be provided even in the absence of location data. Upon reviewing the geographic, audio and/or video information available at the tracking server, the designated user may determine if it is necessary to take further action such as contacting emergency services personnel. The method may facilitate this action at block 306 or, if such action is unnecessary, allow the designated user to terminate the tracking operation and/or disengage from the tracking server.

The illustrations of the embodiments described herein are intended to provide a general understanding of the structure of the various embodiments. For instance, consistent with an exemplary embodiment of the invention, the component for tracking, the component for updating, the component for receiving, and the component for providing may comprise tracking server 170. Those of ordinary skill in the art, however, will appreciate that other elements of system 100 may, by themselves or in conjunction with other elements, comprise the component for tracking, the component for updating, the component for receiving, or the component for providing. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. § 1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A method for providing information about a cellular telephone, the method comprising:
determining that an emergency condition exists;
acquiring a location of the cellular telephone;
acquiring audio, a still image, or a video image from the cellular telephone; and
providing the location and the audio, still image or video image on a server.

2. The method of claim 1 further comprising notifying an interested party that the information is available.

3. The method of claim 2 wherein notifying the interested party comprises sending an email.

4. The method of claim 1 wherein the location of the cellular telephone is determined using a Global Positioning System.

5. The method of claim 1 wherein the location of the cellular telephone is determined using triangulation.

6. The method of claim 1 wherein the cellular telephone includes a main battery and a backup battery.

7. A system for providing information about a cellular telephone, the system comprising:
a server adapted to acquire a location of the cellular telephone when an emergency condition exists, to acquire audio, a still image, or a video image from the cellular telephone, and to provide the location and the audio, still image or video image to an Internet page.

8. The system of claim 7 wherein the server is adapted to notify an interested party that the information is available.

9. The system of claim 7 wherein the server is adapted to send an interested party an email that the information is available.

10. The system of claim 7 wherein the location of the cellular telephone is determined using a Global Positioning System.

11. The system of claim 7 wherein the location of the cellular telephone is determined using triangulation.

12. The system of claim 7 wherein the cellular telephone includes a main battery and a backup battery.

13. A cellular telephone comprising:
a main battery; and
a backup battery to enable the cellular telephone to provide its location in an emergency when the main battery is unavailable.

14. The cellular telephone of claim 13 wherein the backup battery is normally inaccessible.

15. The cellular telephone of claim 13 further comprising a microphone adapted to transmit audio during the emergency.

16. The cellular telephone of claim 13 further comprising a camera adapted to transmit images during the emergency.

17. The cellular telephone of claim 16 wherein the images are still images.

18. The cellular telephone of claim 13 wherein the location of the cellular telephone is determined using a Global Positioning System.

19. A method for providing information about a cellular telephone having main and backup batteries and a camera, the method comprising:
determining that the main battery is unavailable; and
using the backup battery to enable the cellular telephone to provide its location and to provide an image from the camera.

20. The method of claim 19 further comprising providing at least one of the location or image available to an interested party.

21. The method of claim 20 wherein the location of the cellular telephone is provided on an Internet page.

22. The method of claim 21 wherein the location is provided on a map display.

23. The method of claim 19 wherein the location of the cellular telephone is determined using a Global Positioning System.

24. The method of claim 19 further comprising notifying an interested party that at least one of the location or image is available.

25. The method of claim 24 wherein notifying the interested party comprises sending an email.
